(19) United States
(12) Patent Application Publication
(10) Pub. No.: US 2008/0289120 A1
(43) Pub. Date: Nov. 27, 2008

(54) Method for Modifying Polyamide

(75) Inventors: Arja Miettinen-Oinonen, Klaukkala (FI); Johanna Buchert, Espoo (FI); Arja Puolakka, Tampere (FI)

Correspondence Address: SUGHRUE MION, PLLC, 2100 PENNSYLVANIA AVENUE, N.W., SUITE 800, WASHINGTON, DC, 20037, US

(73) Assignee: Valtion Teknillinen Tutkimuskeskus, Espoo (FI)

(21) Appl. No.: 11/629,090

(22) PCT Filed: Jun. 13, 2005
(86) PCT No.: PCT/FI05/00273

§ 371 Date: Dec. 11, 2006

(30) Foreign Application Priority Data
Jun. 11, 2004 (FI) 20040805

(51) Int. Cl. C09B 62/00

(52) U.S. Cl. 8/401

(57) ABSTRACT

The present invention relates to a method for modifying polyamide. The method comprises that polyamide is contacted with an enzyme preparation comprising an effective amount of protease enzyme in aqueous environment under conditions suitable for the function of the enzyme. The enzyme is preferably selected from the group of aspartic proteases, cysteine proteases and metallo-proteases.

### FIELD OF THE INVENTION

The present invention relates to methods for modifying textile fibres. In particular, this invention relates to a method for modifying polyamide and to the polyamide modified by the method of the invention.

### DESCRIPTION OF RELATED ART

Production of textile fibres reached the total amount of 55.4 million metric tons in 2001 (CIRFS and FAO Yearbooks), from which the share of synthetic man-made fibres was 30.1 Mt (54.3%). Polyamides (PA) were produced 3.9 Mt. In accordance with DIN 60001, part 3, 10.88 edition, PA fibres are classified as synthetic man-made fibres, the aliphatic chain links of which are bonded to at least 85% of their mass into linear macromolecules by amide groups. Characteristic of the chain-forming polymers are the continually repeating functional acid amide groupings (CO-NH) in the main chain. The international ISO 2076 standard, 12.89 edition “Generic names for man-made fibres” described polyamides or nylon as chemical fibres, the polymers of which consist of linear (aliphatic) macromolecules with the repeating (CO-NW functional group in the chain. Several polyamide types exist. Polyamides, normally used as fibre materials, are polyamide 66, polyamide 6, polyamide 11, polyamide 12, polyamide 472 (Qiana) and aramids (for example Nomex, Keviar). Aramids are aromatic polyamides commonly used when high-temperature resistance is needed.

About ⅓ of PA is used for clothing. The rest will be equally divided between home furnishing and interior textiles and more rapidly increasing technical, hygienic and medical textiles. Polyamide has a high crystallinity and low moisture regain due to the hydrophobicity of the fibre. PA fibres have a low content of ionic groups on the fibre surface. Due to these properties, fibres are typically dyed at temperatures higher than the glass transition point Tg. Polyamide has also strong tendency to electrostatic charging, which encourages quick soiling. Polyamide has an excellent tenacity, high elasticity and extremely high resistance to abrasion stress.

The properties of PA fibres can be extensively affected by varying the processing parameters. Fibre properties can be modified during fibre manufacture, for example by changing the molecular weight, putting in additives, varying shape of spinneret holes, increasing take-down speed or the extent of drawing, and by heat treatment methods. Several methodologies, such as alkaline treatments, have been developed to render man-made fibres including polyamide more hydrophilic. These treatments lead, however, to deterioration of other product properties. One undesired result is irreversible yellowing of the fibres. Additionally, elevated reaction temperatures, aggressive chemicals and higher concentrations of organic solvents may lead to unwanted changes of the macroscopic behaviour of the fibres. All these treatments have also a negative impact on the environment.

Chemical approaches for fibre modification are not very attractive since drastic conditions have to be used or multistage chemical reactions are required in order to get desired effects on the fibres. In chemical finishing, inadequate fibre properties are often compensated by additional steps in the subsequent finishing processes. Current processing chemicals for PA include detergents, softening agents, water, oil, or soil repellent agents, printing auxiliaries and additives in acid, metal complex and disperse dyeing. In acid dyeing specific levelling additives are used together with acetic or formic acid. Dyeing properties of polyamide can be influenced by means of additives and chain length stabilizers during spinning.

Amino end groups (NH₂), carboxyl end groups (COOH) and amide bonds of molecular chain of PA are reactive groups in dyeing. Acid dyes (for example Nylosan, Telon, Suminol, Erionyl), metal complex dyes (Isolan, Formalan) and reactive dyes (Cibarcon, Levafix, Remazol, Drimaren, Procion) are used for dyeing of polyamide. These dyes are monoazo, azo, diazo and anhraquinone dyes. Acid dyes bind via ionic bonds, metal complex dyes via chelate bonds and reaction dyes via covalent bonds. All dye groups bond also via hydrogen linkage. Because of high crystallinity of PA dyeing need to be performed at high temperatures (over Tg (=70-130° C. for fibres), which means the temperature area, where the rotation movement of chain segments longer than a few atoms in amorphous areas stops when temperature decreases) and also for example levelling of most acid dyes can be enchanced by increasing the dyeing temperature. This results in increased penetration and improved wetfastness. Acid dyes and metal complex dyes need acidic dyeing circumstances. Basic dyes are cationic in nature usually because of a positively charged quaternary amine group in the dye molecule. They can be used for anionic modified PA. Adhesion of cationic compound can be increased by creating carboxyl groups on the fibre surface.

Drawing of PA fibres affects their dye affinity. Dye adsorption is hindered at high degrees of drawing, and therefore staple fibres are easier to dye than highly drawn filament yarn. Dyeing properties can be influenced by means of additives and chain length stabilizers during spinning. The use of mono or dicarboxylic acid as stabilizers produces PA fibres with less dye affinity for acid dyestuffs. The use of primary aliphatic amines or diamines produces a polyamide with increased dye affinity for acid dyestuff. If polyamides are to be dyed with basic dyestuffs, this is made possible by incorporating sulphonium compounds, e.g. 5-sulpho-isophthalic acid, in equimolecular relationship with 1,6-hexanediamine with simultaneous blocking of the amino end-groups.

The modification of PA surface can increase the durability of the finishing agents. For example repellent finishing with fluorochemicals gives the textiles both fastness to moisture and protection against staining and soiling. Most polymeric fluorine-containing repellents in commercial use consist of a polymeric basic structure such as acrylate, polyurethane and perfluorated side chains. Co-monomers with a cross-linking function, such as a hydroxyl, epoxy or vinyl group, are used to increase the durability of the repellent polymer. Also other finishing agents as antistatic agents are mainly applied on synthetic articles together with fluoropolymers.

The existing processes used in processing of PA fibres and fabrics can be particularly damaging to the environment, as they give rise to undesirable pollution, of varying degrees depending on the nature of the process. Due to the quite inert chemical nature of PA polymers and fibres their modification is relatively difficult and requires high amounts of energy and chemicals (binders, coupling agents, dyes etc) in order to obtain the desired end-product (textile materials) properties. A remarkable amount of these chemicals (e.g. dyes) is discharged to the environment. This is due to inefficient finishing processes, which waste water, energy, raw materials and other resources. Subsequent washing steps are required to remove unbound dyes from fabrics. Furthermore, some of the current substances used to render the polymers (fibres) water, oil, and soil repellent (e.g. fluorochemicals) should be avoided, since they have ozone depleting effect at production stage. As a whole, production of PA fibres is not an eco-efficient process, but the fibres have positive properties, which make them superior in certain textiles.

There is thus a great need for polyamide modification processes, which would be less damaging to the environment and which would render polyamide more hydrophilic, save the dyeing chemicals and enable dyeing of PA e.g. at milder pH and/or at lower temperature than the known processes.

Only very few studies have been carried out in the field of treating polyamide by methods alternative to chemical treatments.

Recent scientific studies have shown that white rot fungi are able to degrade polyamide. The culture filtrate of the white rot fungus IZU-154 was able to modify PA66 and PA6 apparently due to the presence of manganese peroxidase-type of enzyme (Deguchi et al., 1998). While the enzymatic treatment caused substantial changes in the surface properties there was no change in the fibre diameter. Nylon oligomers have been degraded with hydrolases mainly from bacterial origin (Negoro, S., Kato, K., Fujiyama, K. and Okada, H. 1994. Biodegradation 5:185-194). Also Prijambada et al. (Prijambada, Negoro, Yomo and Urabe. 1995. Appl. and Environm. Microb. 61:2020-2022) describe the hydrolysis of oligomers.

Japanese Patent No. JP 44003273 mentions the treatment of synthetic polyamide fibres by using a protease product, Prozyme (Kyowa Hakko) from actinomycetes. However, the patent publication does not disclose what type of protease was used in the experiments and there is not either any chemical, biochemical or quantitative data of the effect of the protease. The patent seems not to have solved the problem of polyamide treatment since the patent was filed about 40 years ago, and neither the protease product, Prozyme, nor any other commercial enzyme are available for polyamide modification.

Burkinshaw and Bahojb-Allafan (Dyes and Pigments 60 (2004) 91-102) disclose the aftertreatment of nylon 6,6 dyed with acid dyes with four protease enzymes, serine proteases Savinase, Esperase and Alcalase and metalloprotease, Neutrase. The authors suggest that the enzymes replace the metal salt (potassium antimonyle tartrate) used in the full backtan aftertreatment and that the sequential application of tannic acid and enzyme results in the formation insoluble, tannic acid/enzyme complex that is situated at the surface of the dyed substrate and which provides a physical barrier to the diffusion of dye from the dyed fabric during washing. In the experiments of Burkinshaw and Bahojb-Allafan the enzymes do not modify the polyamide itself.

Smith et al. 1987. The enzymatic degradation of polymers in vitro. J. Biomedical Materials Research 21:991-1003 studied the degradation of synthetic labeled poly(ethylene terephthalate), nylon 66 and poly(methyl metacrylate) with Esterase Papain, Trypsin and Chymotrypsin. The aim of the experiments was to study whether the synthetic labelled polymers are degraded by the enzymes, since their degradation is of importance in medical engineering and pharmaceutical technology. Nylon 66 was degraded by Papain, Trypsin and Chymotrypsin, but not by Esterase.

### SUMMARY OF THE INVENTION

It is an aim of the present invention to eliminate the problems associated with the prior art and to provide a novel process for polyamide modification. In particular, it is an aim of this invention to provide a process with which it is possible to modify the surface properties of polyamide leading to improved textile properties of the treated polyamide. More specifically, it is an aim of this invention to increase the hydrophilicity of polyamide.

This invention is based on the finding that advantageous modifications to polyamide can be obtained by treating polyamide by an enzyme preparation comprising an effective amount of protease enzyme. Furthermore, when changes in the surface chemical properties of protease treated polyamide were studied, differences in the effect of different proteases could be observed. Corresponding changes could be found in the textile properties of protease treated polyamide. This makes possible the selection of proteases, which have most advantageous effects on the surface properties of polyamide.

One object of this invention is a method for modifying polyamide. The method is mainly characterized by what is stated in the characterizing part of claim 1 and claim 23.

One further object of this invention is a polyamide treated by the method of this invention. The polyamide is mainly characterized by what is stated in the characterizing part of claim 24.

According to this invention the protease enzyme belongs preferably to the class of metalloproteases, aspartic proteases or cysteine proteases. Protease enzymes with preferred effects belong to aspartic proteases or cysteine proteases.

The process of this invention is less harmful to the environment than previously used chemical methods. It saves chemicals, gives beneficial functionalities and improves the end-product properties. The modification process improves finishing processes, such as colour, friction, lustre, wettability and repellency.

By using the process of this invention it is possible to develop enzymatic modification and finishing processes for polyamide, with which the eco-efficiency of the whole process can be significantly improved. This improves the dyeing properties. Saving of dyes may be at least 1%, preferably 20%, more preferably 30%. Energy may be saved at least 20%, preferably 30%, more preferably 40%, and most preferably 55%. Saving of washing water may be at least 10%, preferably 20%. Dye exhaustion in dyeing of the fabrics will be substantially increased by the enzyme pre-treatment of the fibres. Consecutively, energy consumption due to lower dyeing temperatures, dye, additive and washing water consumption due to stronger bonding, and dye discharge into effluents will decrease. Concomitantly, the range of applicable dyestuffs will be widened and lower amounts of dyes can be used.

By the present invention the hydrophilicity of polyamide is increased which results in better wetting properties and more comfortable material in many applications, such as clothing. The wettability may be improved at least by 10%, more preferably at least 20% as calculated for example from the contact angle of the polyamide fabric. More carboxylic end groups are available as a result of the treatment. This gives the possibility for resource saving finishing processes through new functionalities.

The use of protease enzymes according to the invention will lead to fibre modifications, which are otherwise with chemical methods not possible or would require drastic conditions leading to damages of the polymers. Furthermore, fibres with new functionalities will open up a wide range of possibilities in dyeing and finishing processes and both new value added end-products or resource saving dyeing and finishing processing will be developed (e.g. less dye and energy, coupling-agents and stiffening substances consumed).

Other features, aspects and advantages of the present invention will become apparent from the following description and appended claims.

### BRIEF DESCRIPTION OF THE FIGURES

FIG. 1. Rising height of water on the polyamide fabric treated with 1000 nkat/g of Bromelain, Papain and Corolase N and 1 mg/g of Flavourzyme. Treatment time A. 1 day, B. 7 days, C. 14 days.

FIG. 2. Contact angles of the polyamide fabric treated with 1000 nkat/g of Bromelain and Corolase N. Treatment time 1 day, 7 days or 14 days.

FIG. 3. Drop test of the polyamide fabric treated with Corolase N, Bromelain and Papain. Treatment time 1 day.

FIG. 4. L-value (lightness) of the protease-treated fabric and reference fabric after dyeing with methylene blue. A. Bromelain and Corolase N dosages 1000 nkat/g, Flavourzyme dosage 1 mg/g. B. Bromelain and Corolase dosages 10000 nkat/g.

FIG. 5. K/S—value of the protease-treated fabric and reference fabric after dyeing with acid dye. 1000 and 10000 nkat/g of Bromelain was used in the enzyme treatments.

FIG. 6. Rising height of water on the polyamide fabric treated with 1000 nkat/g of Bromelain, Papain, and GC 106. Treatment time 2 and 24 hours (values of the plain buffer treatment have been subtracted).

FIG. 7. Contact angles of the polyamide fabric treated with GC 106 (A), Papain, Bromelain and Corolase (B) and Purafect (C). Treatment time 2 and 24 h.

FIG. 8. Colour strength of the protease treated polyamide fabric after dyeing with methylene blue, A: GC 1061000 nkat/g, B: Papain 1000 nkat/g, C. Bromelain 1000 nkat/g, D: Corolase 1000 nkat/g, E: Purafect 1000 nkat/g. Treatment time 2 and 24 h.

FIG. 9. Colour strength of acid dyed polyamide fabric treated with GC 106 (A), Papain (B), Bromelain (C), Corolase (D) and Purafect (E). Treatment time 2 and 24 h.

### DETAILED DESCRIPTION OF THE INVENTION

### Definitions

By the term “polyamide” or “nylon” is here meant chemical, in particular synthetic chemical fibres, the polymers of which consist of linear (aliphatic) macromolecules with the repeating (CO-NH) functional group in the chain. This invention relates in particular to polyamides, which are normally used as fibre materials, such as polyamide 66, polyamide 6, polyamide 11, polyamide 12, polyamide 472 (Qiana) and aramids (for example Nomex, Kevlar). Aramids are aromatic polyamides commonly used when high-temperature resistance is needed. Most important polyamides of this invention are polyamide 6, polyamide 11 and polyamide 66. The present invention relates in particular to the modification of polyamide in textiles.

The term “textile” is here used in its normal meaning defined for example in “Textile terms and definitions”, The Textile Institute, 1995, UK. According to the definition the term textile is applied to fibres, filaments and yarns, natural and manufactured, and most products for which these are a principal raw material. This definition embraces, for example, fibre-based products in the following categories: threads, cords, ropes and braids; woven, knitted and nonwoven fabrics, lace, nets, and embroidery; hosiery, knitwear and made-up apparel; household textiles, soft furnishing and upholstery; carpets and other floorcoverings; technical, industrial and engineering textiles, including geotextiles and medical textiles. The present invention can be used in particular for improving the properties of textiles in clothing, nonwoven fabrics, technical textiles and medical textiles.

“Modification of polyamide” means here modification of surface properties of polyamide to improve textile fibre properties. As an example modification is measured as the amount of released carboxylic end groups from the treated polyamide. Polyamide polymer consists of adipinic acid and hexamine. The release of adipinic acid can be measured as absorbance on wave length 210 from the treatment medium.

By the term “proteases” is meant here hydrolytic enzymes cleaving peptide bonds of proteins. Proteases are classified into four mechanistic classes recognized by the International Union of Biochemistry (Beynon, R. J. and Bond, J. S. (eds.): Proteolytic enzymes. A Practical approach. IRL Press, 1990). Within these classes, six families of proteases are recognized. Each family has a characteristic set of functional amino acid residues arranged in a particular configuration to form the active site. Families of proteolytic enzymes are: serine protease I, serine protease II, cysteine protease, aspartic protease, metallo-protease I and metallo-protease II. Many other proteolytic enzymes have been identified and isolated that do not fit this classification.

By “protease” is in connection of this invention meant in particular serine proteases (EC 3.4.21), aspartic proteases (EC 3.4.23), metallo-proteases (EC 3.4.24) and cysteine proteases (EC 3.4.22). The effect of these enzymes to PA is measured as the release of carboxylic end groups from enzyme treated PA. Significant effects to polyamide are achieved by proteases belonging to metallo-proteases, aspartic proteases and cysteine proteases, in particular aspartic proteases and cysteine proteases, which seem to function in shorter time.

The increased amount of COOH end groups suggests also improved hydrophilicity and wetting of the fabric or other textile. Rising height, contact angle and drop test have been used as methods to measure wettability of the fabric.

The increase of COOH end groups has been shown also indirectly by methylene blue dyeing. Methylene blue is a cationic dye, which binds to COOH groups. NH₂ groups formed due to protease treatment has been shown indirectly by acid dye, which binds to NH₂ groups.

“Rising height of water on the polyamide fabric” measures the wetting rate or wettability of the fabric. The higher the rising height is, the better is the wettability of the fabric.

“Contact angles” indicate also the wetting rate of the fabric. Contact angle of the fabric is measured by applying a drop of distilled water on the surface of the fabric and taking a video film of it. The contact angle is measured of the video film by a special program.

Drop test indicates wetting of the fabric. The lower s-value (seconds), the better wetting. L-value (lightness) measures the improvement of dyeability. The lower the L-value, the darker the colour after dyeing.

K/S-value (colour strength) measures also the improvement of dyebility. The higher the K/S-value, the better the dyeability of the fabric.

Aspartic proteases and cysteine proteases release carboxylic end groups from polyamide efficiently, increase the wettability of polyamide textile and improve the dyeability of the textile. Metallo-proteases have also effect in all these three aspects, although their effect is not as quick as the effect of aspartic proteases and cysteine proteases. The quick function is of advantage to the industry, since the treatment times need not be so long as when working with slower functioning enzymes.

The proteases of this invention can originate from plant or from fungal, yeast, bacterial or other microbial origin. They may be produced, isolated and purified from plants or produced by their natural or recombinant microbial hosts. They may be isolated and/or purified from the host or from the culture medium of the host or the culture medium itself can be used as such, after separation of the cells or after separation of the cells and concentration and/or purification.

Examples of commercial metallo-proteases are Corolase N (AB Enzymes GmbH) and Multifect Neutral (Genencor Intl), aspartic proteases Protease M (Amano Enzyme Europe Ltd), Flavourzyme 500L (Novozymes) and GC 106 (Genencor Intl), and cysteine proteases Bromelain Conc. (Genencor Intl.) and Papain (e.g. Sigma). Examples of commercial serine proteases are Protex Multiplus L (Genencor Intl) and Purafect OX 4000 (Genencor Intl).

The protease enzyme of this invention is preferably used as an enzyme preparation, which may comprise suitable other agents, such as adjuvants, other enzymes etc. The enzyme preparation may be in the form of solution, powder or granules.

The term “enzyme preparation” denotes here to any product, which contains at least one protease enzyme. Thus, such an enzyme preparation may be a culture solution or filtrate containing one or more proteases or one or more proteases and other enzymes, an isolated protease enzyme or a mixture of one or more protease enzymes or a mixture of one or more protease enzymes and one or more other enzymes. In addition to the proteolytic activity such a preparation preferably contains adjuvants, which are commonly used in enzyme preparations intended for application in the textile industry. Such adjuvants are typically comprised of, for instance, buffering agents, stabilizing agents, preservatives and surfactants. Preferably the adjuvants are not harmful to the environment.

The enzyme preparation useful for treating polyamide comprises an effective protease enzyme activity and may contain also another enzyme activity, preferably an enzyme activity having effect on the surface properties of polyamide and/or on the functional groups in polyamide. Preferably the other enzyme activity has effect on the carboxyl or amino groups or both. Preferred enzyme activities are for example oxidoreductases, such as oxidative enzymes. An example of such enzyme is laccase, which may be used in combination with protease.

Alternatively the other enzyme or enzymes may be contacted with polyamide before, during or after the protease treatment. Said other enzyme may be available in a separate enzyme preparation.

The protease treatment may be combined also with one or more suitable chemical treatments, such as alkaline treatment. The chemical treatment should be chosen not to be harmful for the effect of the protease enzyme and preferably also not to the environment.

By an “efficient amount” of protease enzyme is meant the dosage of enzyme with which a significant improvement in textile properties is achieved by modification of the surface of polyamide, for example as a release of significant amount of carboxylic end groups from treated polyamide within the treatment time. The amount of carboxylic end groups released is at least 2 mmol/kg of treated polyamide. A suitable dosage of protease is 20-10000 nkat/g of PA, preferably 20-1000 nkat/g. A suitable method for determining the amount of carboxylic end groups is a method in which PA is diluted in a suitable solvent and carboxylic end group values are determined by titration. The method used to measure the effect of these enzymes to PA is disclosed in detail in Example 1.

“Conditions suitable for the function” of the enzyme are meant conditions under which the enzyme is active and can function. This means temperature and pH, which are suitable for the used enzyme. The protease treatment is carried out at temperature 40-100° C., more preferably at 40-60° C.

The protease treatment is preferably carried out at pH 2.5-12, more preferably at 4-11.

The treatment time can be 30 minutes to 2 weeks. Preferably the treatment time is as short as 30 minutes to 24 hours, more preferably 30 minutes to 2 hours.

The protease treatment should be carried out in aqueous environment. The polyamide/liquid ratio is about 1:10 to 1:30, preferably 1:15 to 1:20. Agitation is preferably used during the treatment in order to obtain a homologous treatment result.

The protease treatment of polyamide results in increase in the amount of carboxylic end groups from the treated polyamide. A significant effect is achieved, when the increase is at least 2 mmol/kg of the treated polyamide compared to untreated polyamide. More significant effect can be achieved, when the increase is at least 2.5 mmol/kg, preferably 3 mmol/kg, more preferably the increase is at least 3.5 mmol/kg of the treated polyamide compared to untreated polyamide.

The treatment of polyamide can be carried out at any stage of polyamide process from fibre to textile product. The treatment can be carried out on fibre, filament fibre and yarn, spun yarn, on woven or knitted polyamide containing textile, or clothing containing polyamide.

The filament, yarn, fabric, clothing or other textile may be a blend of synthetic or synthetic and natural fibres. The blend comprises preferably at least 10% polyamide, more preferably at least 50%, still more preferably at least 70%, most preferably at least 80% polyamide.

The enzyme treatment of this invention can be carried out on polyamide before dyeing, during dyeing or even a dyed polyamide can be treated by proteases according to the invention. If the treatment is carried out in the same process as dyeing, the protease should be chosen to be functional in the conditions of the dyeing process.

In the dyeing process it is possible to use acid, metal complex or dispersion dyes. The dyeing is usually carried out at high temperatures and in low pHs. The temperatures are usually 80 to 100° C. and the pH is usually 4 to 7. Suitable proteases in these conditions are for example Corolase N (AB Enzymes Oy) and Neutrase (Novozymes).

The dyeing and protease treatment time should be chosen to be suitable for both of the processes.

If the protease treatment is carried out before dyeing the protease need naturally not be functional under the conditions of the dyeing process.

Before the protease treatment of polyamide, in the form of fibre, filament, or other textile, pretreatment to remove oils, waxes or other chemicals may be necessary. For example filament or fabric may comprise oils used in spinning. From filament the oils can be washed for example by ethyl ether, from fabric the oils can be removed by normal washing with different special detergents.

The treatment can be carried out in washing machines used industrially for polyamide treatments and for example in dyeing. No special equipment is needed, since the treatment is much more gentle than the prior art chemical treatments.

The protease treatment can be stopped simple by rinsing with water, or depending on the protease used, by raising the temperature, if the enzyme does not resist high temperatures, or by lowering the pH, if the protease does not resist low pH. The protease may be denatured in the dyeing conditions and the treatment need not to be actively stopped.

As described above, protease treatment releases carboxylic end groups from treated polyamide. Also the same amount of amino groups is released, although the amount of released amino groups was not determined here. The presence of released carboxylic and amino end groups opens up the possibility of adding various functional groups, such as the functional groups of finishing or dyeing substances, to the end groups, with better adhesion.

The following non-limiting examples further illustrate the invention:

### EXAMPLES

### Example 1

### Increase of Carboxylic End Groups of Polyamide 6.6 Monofilament with Proteases

Two types of polyamide 66 monofilament yarns (PA yarns, Type F111, diameter 0.035 mm and Type D183 diameter 0.5 mm, Rhodia Industrial Yarns AG, Emmenbrücke, Switzerland) were treated with protease enzymes. Before enzyme treatments PA yarns were extracted with diethyl ether to remove spin finishes. Extraction was performed in a Soxhlet-Extractor and about 150 ml diethylether was used for the extraction of about 10 g polyamide. Extraction time was 2 hours. After extraction the filaments were air dried.

2 g PA yarn was treated in 0.1 M Na-phosphate buffer 7 or 0.1 M Na-citrate pH 4.5 in liquid ratio 1:15 with 20 and 1000 nkat protease/g of yarn at 50° C. for 2 and 24 h. Protease activity (nkat) was measured as in example 2. Four different types of commercial protease enzymes were used: Protex Multiplus L (Genencor Intl, serine protease, treatment pH 7), Corolase N (AB Enzymes GmbH, metallo-protease, pH. 7), Bromelain Conc. (Genencor Intl., cysteine protease, pH 7) and Protease M (Amano Enzyme Europe Ltd., aspartic protease, pH 4.5). The reference treatments were done as the enzyme treatment but without enzyme. After the treatment the reactions were stopped by boiling the treatment solution with the yarn for 10 minutes. The yarns were rinsed with water and air dried. Free Carboxylic-End groups (CEG) of polyamide samples were measured by diluting the polyamide sample in a suitable solvent and measuring CEG values by potentiometric titration with a method of Rhodia Industrial Yarns AG (Emmenbrücke, Switzerland, method AG, Q2-424.1e). A summary of the method is described as follows:

### Solvents/Reagents:

Hydrochloric acid c(HCL)=0.1 mol/l
Tetrabutylammonium-hydroxyde (TBAOH)c(TBAOH)=0.1 mol/l
Acetic acid 99-100%

### Chloroform Purum

2,2,2-trifluoroethanol TFE min. 99.8%
Anhydrous lithium chloride puriss

### Instruments:

Titration stand equipped with 2 burettes 10+20 ml
LL solvotrode Metrohm 6.0229.100 filled with ethanolic solution of Lithium chloride

### Laboratory Equipment

### Sample Preparation

Yarn samples have to be washed with deionised water and dried before analysis
Solventforpolymer: 1540 ml THF+460 ml chloroform
TBAOH solution: 11 aqueous TBAOH solution+1.14 ml acetic acid+11 TFE
Titration media: 11c(HCl)=0.1 mol/l+11 distilled water

### Analysis

Solution of samples: 1 g of sample is dissolved in 50 ml solvent for polymer. Dissolution at room temperature, dissolution time max. 90 min.

For measurement of blank value, 50 ml of solvent and exactly 8 ml of TBAOH solution are titrated with titration media. Before an analysis series, 4 blank values are measured. The first result is discarded.

V1=first inflection point, V2=second inflection point (mean of 3 blank runs).

For sample measurement add to the sample solution exactly 8 ml of TBAOH solution and titrate with titration media. V3 first inflection point, V4 second inflection point

Calculation of results:

$$Carboxylic Endgroups \text{:} \frac{\begin{matrix}( V 4 - V 3 - V 2 + V 1 ) \times \\ 1000 \times 0.05 mol \text{/} mL\end{matrix}}{E} = mol \text{/} t CEG$$

E=weighted sample in g

### Measurement Uncertainty

### CEG: 1.3%

The amount of carboxylic endgroups was increased in the monofilament treated with aspartic protease Protease M, cysteine protease Bromelain and metallo-protease Corolase N as compared to the treatment with plain buffer (Table 1). Cysteine protease and aspartic protease functioned in shorter time than metalloprotease.

TABLE 1
Carboxylic end groups of the protease
treated PA monofilament samples.

| | | | |
|---|---|---|---|
| | | | Carboxylic endgroups |
| Enzyme | Dosage nkat/g | Time, h | mmol/kg |

A.

| | | | |
|---|---|---|---|
| — | — | 2 | 81.0 |
| Protease M | 20 | 2 | 85.6 |
| Corolase N | 20 | 2 | 82.9 |
| Bromelain conc. | 20 | 2 | 84.9 |
| Protex Multiplus L | 20 | 2 | 83.8 |
| — | — | 24 | 82.6 |
| Protease M | 20 | 24 | 88.1 |
| Corolase N | 20 | 24 | 85.9 |
| Bromelain Corp. | 20 | 24 | 89.7 |
| Protex Multiplus L | 20 | 24 | 82 .3 |

B.

| | | | |
|---|---|---|---|
| — | — | 2 weeks | 58.6 |
| Corolase N | 1000 | 2 weeks | 62.1 |
| Bromelain conc. | 1000 | 2 weeks | 67.1 |
| Protex Multiplus L | 1000 | 2 weeks | 58.7 |

a. Monofilament Type D183,
b. Monofilament Type F111.

### Example 2

### Improvement of Hydrophilicity of Polyamide Fabric with Proteases

Polyamide 66 fabric (63 g/m², Rhodia Industrial Yarns AG, Emmenbrücke, Switzerland) was washed with OMO detergent (Lever Faberge) in a domestic washing machine Hoover with a washing programme no. 7 at 40° C. to remove the spin finishes. 2 g PA fabric was treated in 0.1 M Na-phosphate buffer 7 or Na-citrate buffer pH 5 in liquid ratio 1:20 with 1000 nkat and 10000 nkat/g of fabric Bromelain, 1000 nkat/g Papain and Corolase N or with 1 mg protein/g of fabric Flavourzyme at 50° C. for 1, 7 and 14 days. Protease activity (nkat) was measured according to Endo-protease assay using Protazyme AK tablets (Megazyme International Ireland Ltd., Ireland). The protein concentration was measured according to Lowry et al. (Lowry, O. H., N. J. Rosebrough, A. L. Farr, and R. J. Randall. 1951. Protein measurement with the Folin phenol reagent. J. Biol. Chem. 193:265). Different commercial protease enzymes were used: Bromelain (cysteine protease Genencor Intl, pH 7), P4762 (papain from Papaya latex, cysteine protease, Sigma, pH 7) Corolase N (metallo-protease, AB Enzymes GmbH, pH 7), Flavourzyme 500L (aspartic protease, Novozymes, pH 5). Reference treatment was performed as enzyme treatments but without enzyme. The enzyme reaction was stopped by boiling the reaction mixture for 10 min. The fabrics were rinsed with distilled water. The effects were evaluated by determining the wetting rate (velocity) as rising height (DIN 53924) and contact angle and by making a drop test (BS 4554). Contact angle of the fabric was measured by applying a drop of distilled water on the surface of the fabric and taking a video film of it. The contact angle was measured of the video film by a special program. The measuring device consists of Panasonic video camera with TV ZOOM lens 18-108 mm F 2.5, Panasonic AG-7355 video cassette recorder, 10 ml injection needle with automatic presser device and measuring program “pisara” made by Fotocomp Oy (Finland).

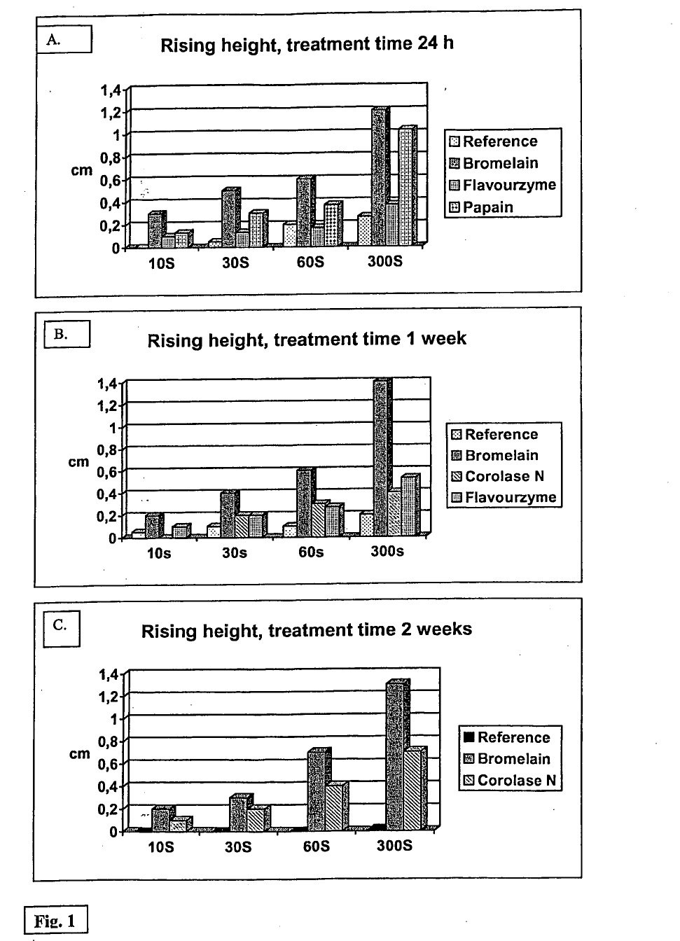

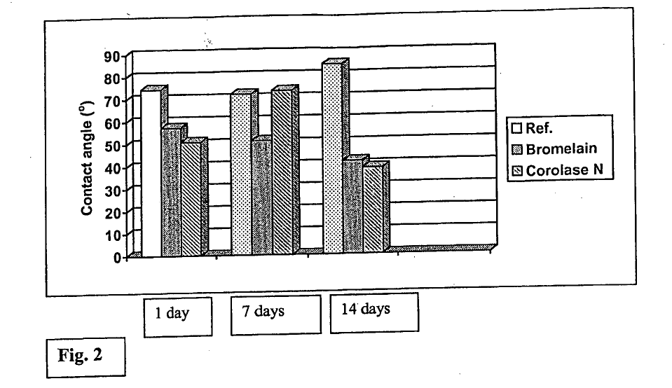

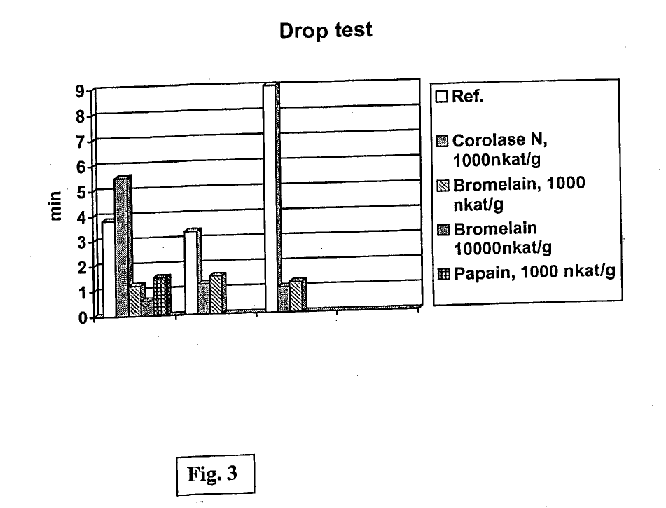

Rising height of the fabric treated with cysteine proteases Bromelain and papain was increased as compared with the reference after 1 day's treatment time (FIG. 1). The effect was the same with Bromelain-treated fabric after 7 and 14 days. The wettability of the fabric measured by drop test was improved after Bromelain and papain treatment already after 1 day's treatment time (FIG. 3). Corolase N improved wettability measured as rising height after 14 days of incubation and drop test after 7 and 14 day's of incubation. Contact angles of the Bromelain-treated fabric decreased as compared with the reference after 1 day's treatment time (FIG. 2). The effect was slightly improved further after 7 and 14 days. Contact angles of the Corolase N-treated fabric decreased as compared with the reference after 1 day's and 2 weeks treatment times.

Based on the results, hydrophilicity of PA fabric can be significantly improved by using cysteine proteases Bromelain and papain. A clear improvement of hydrophilicity can be obtained also with metallo-protease Corolase N and acid protease Flavourzyme.

### Example 3

### Improvement of Dyeing Properties of Polyamide Fabric with Proteases Methylene Blue Dyeing

Polyamide 66 fabric was treated with 1000 and 10000 nkat/g of Bromelain Conc. (Genencor Intl), 1000 nkat/g Corolase N (AB Enzymes GmbH) and with 1 mg/g of Flavourzyme (Novozymes) as described in example 2. Enzyme-treated fabrics were dyed with methylene blue, which is a cationic dye.

Methylene blue dyeing was performed at 85° C. with 0.1% methylene blue (Methylene blue B, Merck) at liquid ratio 1:100 for 5 min. Excess dye was rinsed from the fabrics with water. Dyed fabrics were dried on filter paper over night. Colour of the fabric was measured with Minolta Chroma Meter using L*a*b* system.

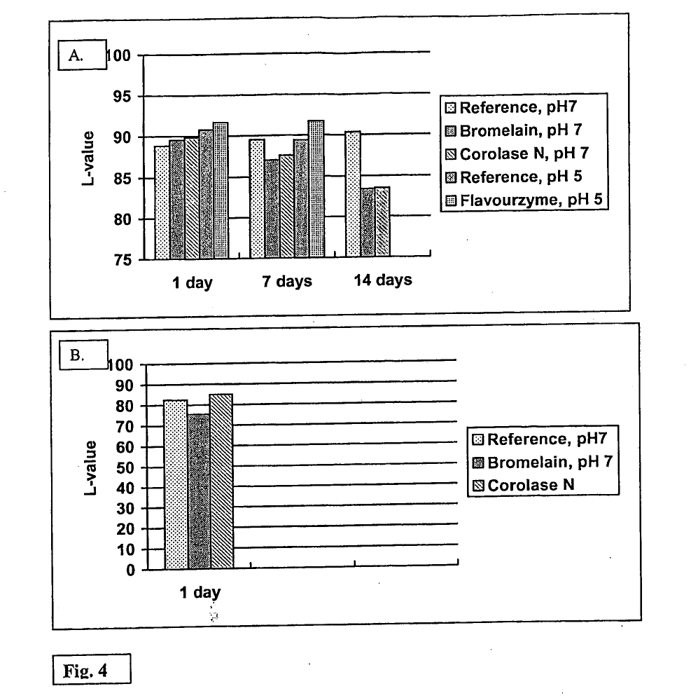

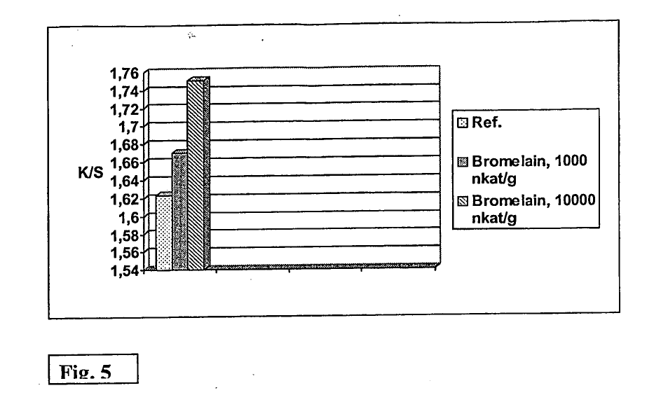

L-value (lightness) was clearly decreased in both Bromelain (1000 and 10000 nkat/g) and Corolase N (1000 nkat/g) treated fabrics after dyeing with methylene blue indicating better dyeing as compared to the reference (FIGS. 4A and 4B). Dyeing was improved according to the enzyme dosage with Bromelain. The effect of Corolase was seen after 7 and 14 after treatment.

### Example 4

### Improvement of Dyeing Properties of Polyamide Fabric with Proteases: Acid Dyes

Polyamide 66 fabric was treated with 1000 and 10000 nkat/g of Bromelain Conc. (Genencor Intl) as described in example 2. Enzyme-treated fabrics were dyed with C.I. Acid Dye 45.

Acid dyeing was performed 100° C. with 5% Acid Dye 0.45. and 4% formic acid (90%) at liquid ratio 1:100 for 20 min. Excess dye was rinsed from the fabrics with water, Dyed fabrics were dried on drying net over night. Colour of the fabric was measured with Minolta CM-1000R spectrophotometer.

K/S-value (colour strength: K/S=(1−R)²/2R, where R is the reflectance value) was increased with both dosages of Bromelain-treated fabrics after dyeing with acid dye indicating better dyeing as compared to the reference (FIG. 5). The effect of Bromelain was improved according to the dosage.

### Example 5

### Improvement of Hydrophilicity of Polyamide Fabric with Proteases: Short Treatment Time

Polyamide 66 fabric (multifilament, dtex 235f34; Rhodia Industrial Yarns AG, Emmenbrücke, Switzerland) was washed with OMO detergent (Lever Faberge) in a domestic washing machine Hoover with a washing programme no. 7 at 40° C. to remove the spin finishes. 2 g PA fabric was treated in 0.1 M Na-phosphate buffer 7 and 8 or Na-citrate buffer pH 5 in liquid ratio 1:20 with 1000 nkat/g of fabric Bromelain, Papain, Corolase N, Purafect OX 4000 E and GC 106 at 50° C. for 2 and 24 hours. Protease activity (nkat) and protein concentration were measured as in example 2. Different commercial protease enzymes were used: Bromelain (cysteine protease Genencor Intl, pH 7), P4762 (papain from Papaya latex, cysteine protease, Sigma, pH 7) Corolase N (metallo-protease, AB Enzymes GmbH, pH 7), Purafect OX 4000 E (serine protease, Genencor Intl., pH 8) and GC 106 (acid protease from Genencor Inc., pH 5). Reference treatment was performed as enzyme treatments but without enzyme. The enzyme reaction was stopped by boiling the reaction mixture for 10 min. The fabrics were rinsed with distilled water. The effects were evaluated by determining the wetting rate (velocity) as rising height (DIN 53924) and contact angle as in example 2

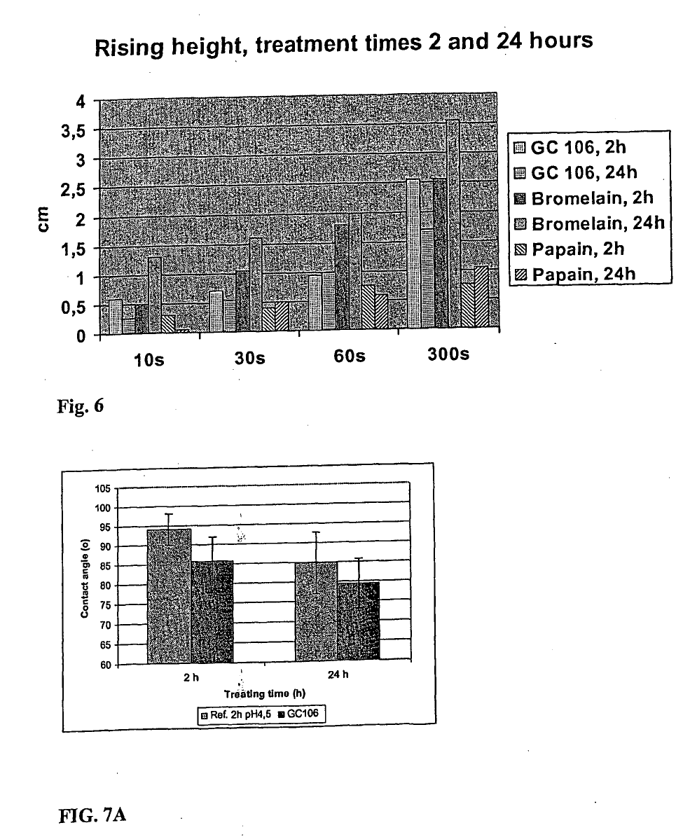

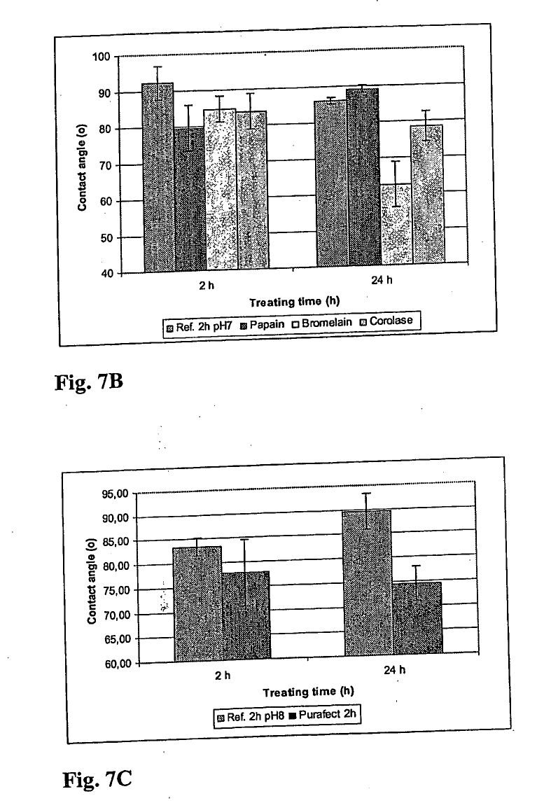

Results of rising height and contact angle of polyamide fabric treated with proteases for short treatment time (2 hours) and for 24 hours are shown in FIGS. 6 and 7. Rising height of the fabric treated with the cysteine proteases Bromelain and papain and with the acid protease GC 106 was clearly improved already after 2 hours treatment as compared to the reference (FIG. 6). Contact angles of polyamide fabrics treated (short time) with GC 106, Papain, Bromelain and Corolase were clearly decreased as compared to the reference fabric treated only with buffer (FIG. 7A-B). Contact angle of Purafect-treated fabric was also decreased (FIG. 7C).

Based on the results, hydrophilicity of PA fabric can be significantly improved by using cysteine proteases and acid proteases. An improvement of hydrophilicity can also be obtained with metallo-protease.

Serine protease increased slightly hydrophilicity in this experiment, but as shown earlier, it did not increase carboxylic end groups or improve the dyeability.

### Example 6

### Improvement of Dyeing Properties of Polyamide Fabric with Proteases (Short Treatment Time): Methylene Blue Dyeing

Polyamide 66 fabric (multifilament, dtex 235f34; Rhodia Industrial Yarns AG, Emmenbrücke, Switzerland) was treated with 1000 nkat/g of Bromelain Conc. (Genencor Intl), Corolase N (AB Enzymes GmbH), GC 106 (Genencor Int.), Purafect OX 4000 E (Genencor Int.) and P4762 (papain from Papaya latex, Sigma) as described in example 5. Enzyme-treated fabrics were dyed with methylene blue, which is a cationic dye.

Polyamide fabric was dyed with methylene blue as follows: 20° C.->100° C., 30 min and 100° C., 30 min. Excess dye was rinsed from the fabrics with water. Dyed fabrics were dried on filter paper over night. Colour of the fabric was measured with Minolta CM-1000R spectrophotometer. The colour values of the fabric were measured during the dyeing.

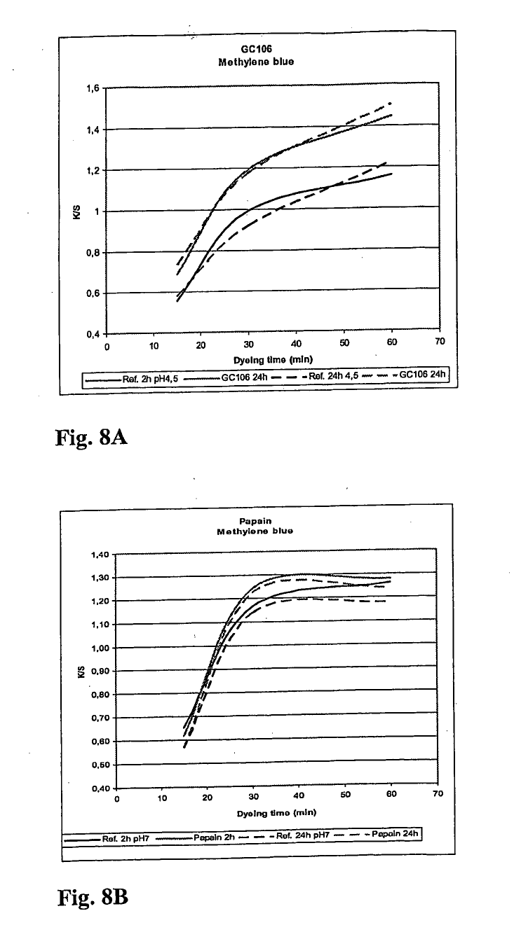

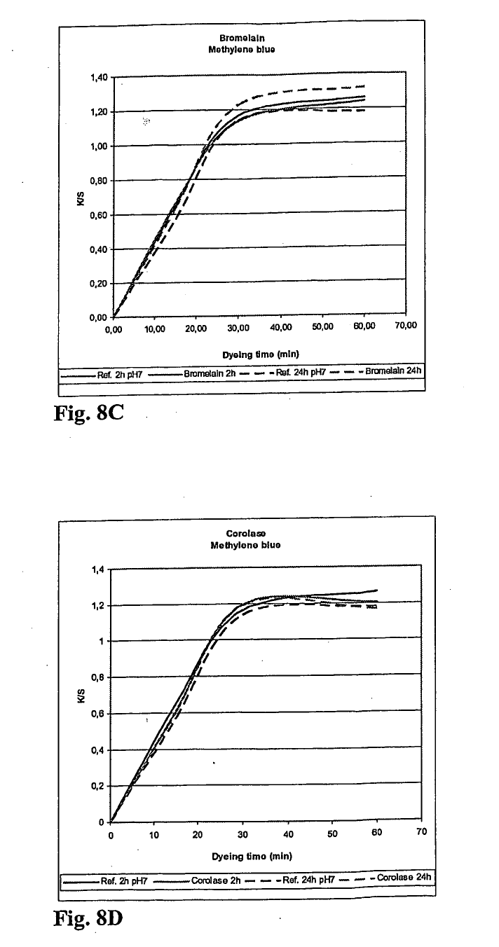

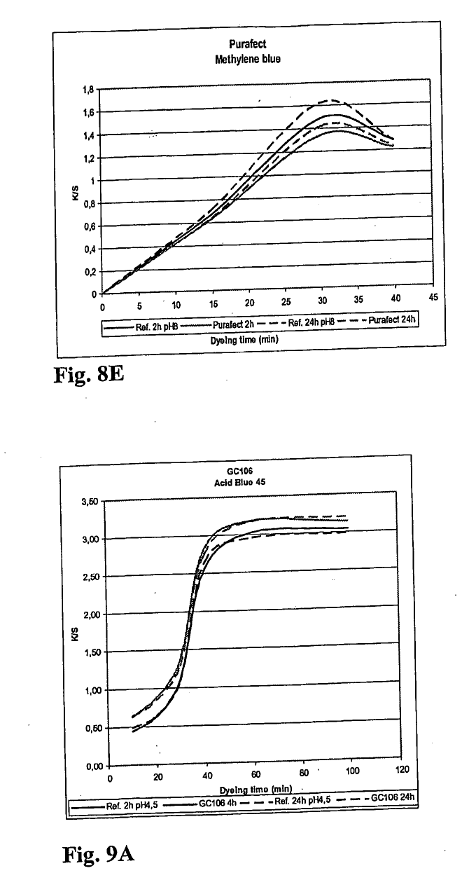

Methylene blue dyed GC106 treated fabrics have better colour strength during the whole dyeing time compared to the reference fabric (FIG. 8A). Papain has also increased colour strength of fabric 2 after 20 minutes (FIG. 8B). Bromelain treated fabric 2 is darker than reference after 24 h treatment (FIG. 8C). Corolase and Purafect had no effect on the colour strength of the fabrics 2 (FIGS. 8D-E). Improved dyeing efficiency with methylene blue suggests the increase of carboxylic groups on the surface of the fabric after protease treatment.

The results indicate that aspartic protease and cysteine protease increase carboxylic groups on the surface of the fabric efficiently. With aspartic protease better dyeing as compared to the reference was obtained during the whole dyeing cycle.

### Example 7

### Improvement of Dyeing Properties of Polyamide Fabric with Proteases (Short Treatment Time): Acid Dyes

Polyamide 66 (multifilament, dtex 235f34; Rhodia Industrial Yarns AG, Emmenbrücke, Switzerland) was treated with 1000 nkat/g of Bromelain Conc. (Genencor Intl), Corolase N (AB Enzymes GmbH), GC 106 (Genencor Intl.), Purafect OX 4000 E (Genencor Intl.) and P4762 (papain from Papaya latex, Sigma) as described in example 5. Enzyme-treated fabrics were dyed with C.I. Acid Dye 45.

Acid dyeing of the fabric was performed as follows: 40° C., 10 min, 40° C.->100° C., 30 min and 100° C. 60 min, 4% C.I. Acid Dye 45 of fabric and 1% formic acid (90%/0) at liquid ratio 1:50. Excess dye was rinsed from the fabrics with water. Dyed fabrics were dried over night. Colour of the fabric was measured with Minolta CM-1000R spectrophotometer. The colour values of the fabric were measured during the dyeing.

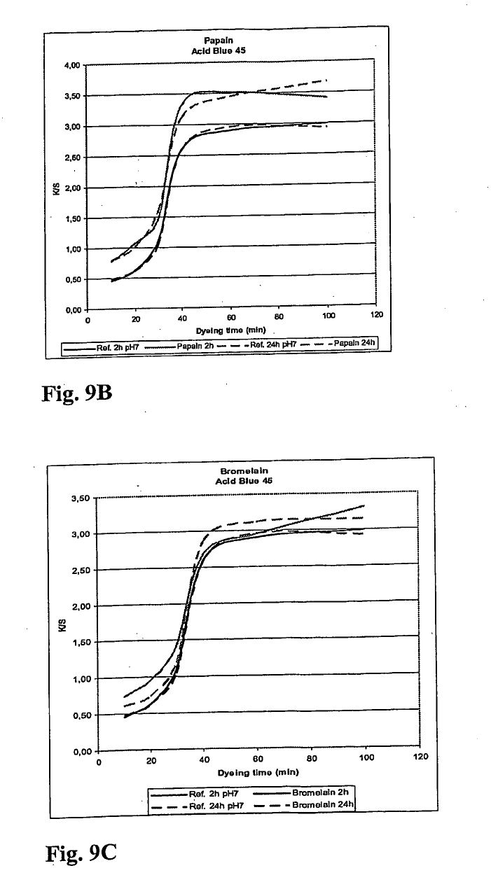

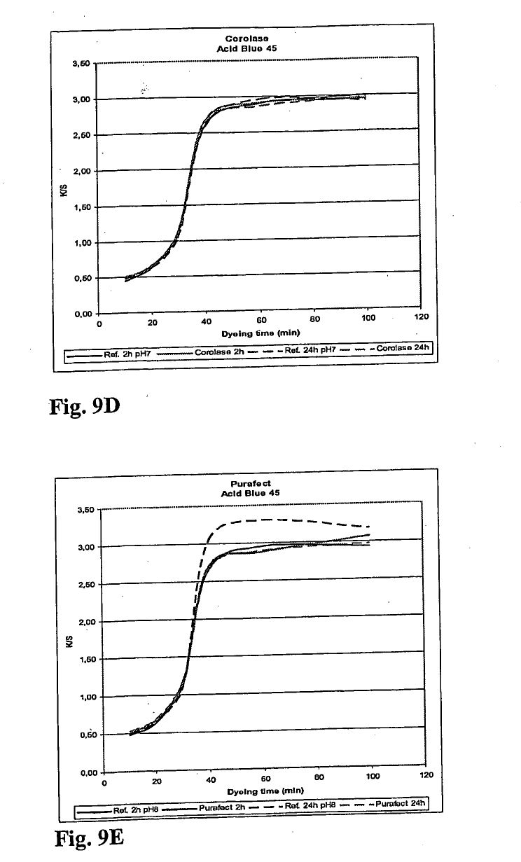

Colour strength of GC106 treated fabric is better during the whole dyeing time compared to the reference. The results are the same with both treating times 2 h and 24 h (FIG. 9A). Papain treated fabric has better colour strength all the time and there is no difference between treating times (FIG. 9B). In the beginning Bromelain treated fabric has better colour strength, but after 40 minutes only 24 h treated fabric is darker than the reference FIG. 9C). After 100 minutes both Bromelain treated fabrics are darker, so we can say that also Bromelain has increased the colour strength (FIG. 9C). Corolase and Purafect treated fabrics have the same colour strength than the reference with both treating times (FIG. 9D-E). Protease treatment has potentially created more amino groups on the fabric and the colour strength of acid dye has increased.

1. A method for modifying synthetic polyamide with an enzyme preparation, characterized in that polyamide is contacted at any stage of polyamide process from fibre to textile product with an enzyme preparation comprising an effective amount of protease enzyme in aqueous environment under conditions suitable for the function of the enzyme, said protease enzyme being selected from the group of aspartic proteases, metallo-proteases and cysteine proteases.

2. The method according to claim 1, wherein the protease treatment results in modification of surface properties of the treated polyamide leading to improved textile properties.

3. The method according to claim 1, wherein the modification is measured as an increase in the amount of carboxylic end groups and the increase is at least 2 mmol/kg of the treated polyamide compared to untreated polyamide.

4. The method according to claim 1, wherein the enzyme preparation comprises a protease enzyme selected from the group of aspartic proteases.

5. The method according to claim 1, wherein the enzyme preparation comprises a protease enzyme selected from the group of cysteine proteases.

6. The method according to claim 1, wherein the enzyme preparation comprises a protease enzyme selected from the group of metallo-proteases.

7. The method according to claim 1, wherein the enzyme preparation comprises a combination of one or more of the protease enzymes.

8. The method according to claim 1, wherein polyamide is in the form of fibre, filament fibre or yarn, spun yarn, fabric or clothing.

9. The method according to claim 8, wherein the filament, yarn, fabric or clothing is a blend of synthetic or synthetic and natural fibres.

10. The method according to claim 1, wherein polyamide is selected from the group of polyamide 6, polyamide 11 and polyamide 66.

11. The method according to claim 1, wherein the enzyme treatment is carried out at temperature 40-100° C.

12. The method according to claim 1, wherein the enzyme treatment is carried out at pH 4-11.

13. The method according to claim 1, wherein the enzyme treatment is carried out in 30 minutes to 2 weeks, preferably in 30 minutes to 24 hours, more preferably in 30 minutes to 2 hours.

14. The method according to claim 1, wherein the protease enzyme dosage is 20-10000 nkat/g of polyamide.

15. The method according to claim 1, wherein the enzyme treatment is carried out before dyeing.

16. The method according to claim 1, wherein the enzyme treatment is carried out in the same process with dyeing.

17. The method according to claim 1, wherein the enzyme treatment is carried out to dyed polyamide.

18. The method according to claim 1, wherein the protease enzyme treatment is combined with another enzyme treatment, wherein said enzyme is selected from the group of enzymes modifying surface properties of polyamide and/or functional groups of polyamide, preferably carboxyl and/or amino groups.

19. The method according to claim 18, wherein the enzyme is selected from the group of oxidoreductases, preferably from the group of oxidative enzymes.

20. The method according to claim 18, wherein the other enzyme is available in a separate enzyme preparation.

21. The method according to claim 1, wherein the protease enzyme treatment is combined with a chemical treatment.

22. The method according to claim 1, wherein the protease enzyme originates from plant or from microbial origin.

23. Synthetic polyamide in the form of fibre, filament fibre or yarn, spun yarn, fabric or clothing treated by the method according to claim 1 comprising at least 2 mmol/kg more carboxylic end groups than untreated polyamide.
